(19) United States
(12) Patent Application Publication
(10) Pub. No.: US 2007/0121555 A1
(43) Pub. Date: May 31, 2007

(54) POSITIONING USING IS-95 CDMA SIGNALS

(76) Inventor: David Burgess, Fairfield, CA (US)

Correspondence Address: LAW OFFICE OF RICHARD A. DUNNING, JR., 343 SOQUEL AVENUE, SUITE 311, SANTA CRUZ, CA, 95062, US

(21) Appl. No.: 11/557,368

(22) Filed: Nov. 7, 2006

Related U.S. Application Data
(60) Provisional application No. 60/734,617, filed on Nov. 8, 2005.

(51) Int. Cl. H04B 7/216

(52) U.S. Cl. 370/335

(57) ABSTRACT

Apparatus having corresponding methods and computer-readable media comprise a receiver to receive a wireless Code Division Multiple Access (CDMA) signal comprising a continuously transmitted pseudonoise sequence; and a pseudorange unit to determine a pseudorange based on the wireless CDMA signal; wherein a location of the receiver is determined based on the pseudorange and a location of a transmitter of the wireless CDMA signal.

### CROSS-REFERENCE TO RELATED APPLICATIONS

This application claims benefit of 60/734,617 Nov. 8, 2005, the disclosure thereof incorporated by reference herein in its entirety.

### BACKGROUND

The present invention relates generally to location determination. More particularly, the present invention relates to location determination using one or more wireless Interim Standard 95 (IS-95) Code Division Multiple Access (CDMA) signals.

### SUMMARY

In general, in one aspect, the invention features an apparatus comprising: a receiver to receive a wireless Code Division Multiple Access (CDMA) signal comprising a continuously transmitted pseudonoise sequence; and a pseudorange unit to determine a pseudorange based on the wireless CDMA signal; wherein a location of the receiver is determined based on the pseudorange and a location of a transmitter of the wireless CDMA signal.

In some embodiments, the wireless CDMA signal comprises at least one of: an Interim Standard 95 (IS-95) signal; and a cdma2000 signal. Some embodiments comprise a location unit to determine the location of the receiver based on the pseudorange and the location of the transmitter of the wireless CDMA signal. In some embodiments, the wireless CDMA signal comprises a pilot channel comprising a short code sequence, and the pseudorange unit determines the pseudorange based on the short code sequence. In some embodiments, the receiver receives a plurality of the wireless CDMA signals, wherein each of the wireless CDMA signals comprises a pilot channel comprising a short code sequence, wherein each of the short code sequences has a different offset index; and the pseudorange unit identifies a respective transmitter for each of the wireless CDMA signals based on the respective offset indexes of the short code sequences. Some embodiments comprise a time transfer unit to receive an indication of absolute time; wherein the pseudorange unit determines the offset indexes of the short code sequences based on the absolute time. In some embodiments, the pseudorange unit determines differences between the offset indexes of the short code sequences, and identifies the respective transmitter for each of the wireless CDMA signals based on the differences between the offset indexes. In some embodiments, the pseudorange unit identifies the respective transmitter for each of the wireless CDMA signals based on a database of the differences between the offset indexes. Some embodiments comprise a wireless CDMA decoder to identify at least one of the transmitters of the wireless CDMA signals based on transmitter identifiers encoded into the respective wireless CDMA signals.

In general, in one aspect, the invention features an apparatus comprising: receiver means for receiving a wireless Code Division Multiple Access (CDMA) signal comprising a continuously transmitted pseudonoise sequence; and pseudorange means for determining a pseudorange based on the wireless CDMA signal; wherein a location of the receiver means is determined based on the pseudorange and a location of a transmitter of the wireless CDMA signal.

In some embodiments, the wireless CDMA signal comprises at least one of: an Interim Standard 95 (IS-95) signal; and a cdma2000 signal. Some embodiments comprise location means for determining the location of the receiver based on the pseudorange and the location of the transmitter of the wireless CDMA signal. In some embodiments, the wireless CDMA signal comprises a pilot channel comprising a short code sequence: wherein the pseudorange means determines the pseudorange based on the short code sequence. In some embodiments, the receiver means receives a plurality of the wireless CDMA signals, wherein each of the wireless CDMA signals comprises a pilot channel comprising a short code sequence, wherein each of the short code sequences has a different offset index; and the pseudorange means identifies a respective transmitter for each of the wireless CDMA signals based on the respective offset indexes of the short code sequences. Some embodiments comprise time transfer means for receiving an indication of absolute time; wherein the pseudorange means determines the offset indexes of the short code sequences based on the absolute time. In some embodiments, the pseudorange means determines differences between the offset indexes of the short code sequences, and identifies the respective transmitter for each of the wireless CDMA signals based on the differences between the offset indexes. In some embodiments, the pseudorange means identifies the respective transmitter for each of the wireless CDMA signals based on a database of the differences between the offset indexes. Some embodiments comprise decoder means for identifying at least one of the transmitters of the wireless CDMA signals based on transmitter identifiers encoded into the respective wireless CDMA signals.

In general, in one aspect, the invention features a method comprising: receiving, at a receiver, a wireless Code Division Multiple Access (CDMA) signal comprising a continuously transmitted pseudonoise sequence; and determining a pseudorange based on the wireless CDMA signal; wherein a location of the receiver is determined based on the pseudorange and a location of a transmitter of the wireless CDMA signal.

In some embodiments, the wireless CDMA signal comprises at least one of: an Interim Standard 95 (IS-95) signal; and a cdma2000 signal. Some embodiments comprise determining the location of the receiver based on the pseudorange and the location of the transmitter of the wireless CDMA signal. In some embodiments, the wireless CDMA signal comprises a pilot channel comprising a short code sequence: wherein the pseudorange means determines the pseudorange based on the short code sequence. Some embodiments comprise receiving a plurality of the wireless CDMA signals, wherein each of the wireless CDMA signals comprises a pilot channel comprising a short code sequence, wherein each of the short code sequences has a different offset index; and identifying a respective transmitter for each of the wireless CDMA signals based on the respective offset indexes of the short code sequences. Some embodiments comprise receiving an indication of absolute time; and determining the offset indexes of the short code sequences based on the absolute time. Some embodiments comprise determining differences between the offset indexes of the short code sequences; and identifying the respective transmitter for each of the wireless CDMA signals based on the differences between the offset indexes. Some embodiments comprise identifying the respective transmitter for each of the wireless CDMA signals based on a database of the differences between the offset indexes. Some embodiments comprise identifying at least one of the transmitters of the wireless CDMA signals based on transmitter identifiers encoded into the respective wireless CDMA signals.

In general, in one aspect, the invention features computer-readable media embodying instructions executable by a computer to perform a method comprising: receiving, at a receiver, a wireless Code Division Multiple Access (CDMA) signal comprising a continuously transmitted pseudonoise sequence; and determining a pseudorange based on the wireless CDMA signal; wherein a location of the receiver is determined based on the pseudorange and a location of a transmitter of the wireless CDMA signal.

In some embodiments, the wireless CDMA signal comprises at least one of: an Interim Standard 95 (IS-95) signal; and a cdma2000 signal. In some embodiments, the method further comprises: determining the location of the receiver based on the pseudorange and the location of the transmitter of the wireless CDMA signal. In some embodiments, the wireless CDMA signal comprises a pilot channel comprising a short code sequence: wherein the pseudorange means determines the pseudorange based on the short code sequence. In some embodiments, the method further comprises: receiving a plurality of the wireless CDMA signals, wherein each of the wireless CDMA signals comprises a pilot channel comprising a short code sequence, wherein each of the short code sequences has a different offset index; and identifying a respective transmitter for each of the wireless CDMA signals based on the respective offset indexes of the short code sequences. In some embodiments, the method further comprises: receiving an indication of absolute time; and determining the offset indexes of the short code sequences based on the absolute time. In some embodiments, the method further comprises: determining differences between the offset indexes of the short code sequences; and identifying the respective transmitter for each of the wireless CDMA signals based on the differences between the offset indexes. In some embodiments, the method further comprises: identifying the respective transmitter for each of the wireless CDMA signals based on a database of the differences between the offset indexes. In some embodiments, the method further comprises: identifying at least one of the transmitters of the wireless CDMA signals based on transmitter identifiers encoded into the respective wireless CDMA signals.

The details of one or more implementations are set forth in the accompanying drawings and the description below. Other features will be apparent from the description and drawings, and from the claims.

### DESCRIPTION OF DRAWINGS

FIG. 1 shows a positioning system according to some embodiments of the present invention.

FIG. 2 shows a process for the terminal of FIG. 1 according to some embodiments of the present invention.

FIG. 3 graphically illustrates an example correlation result y(t) for the positioning system of FIG. 1.

The leading digit(s) of each reference numeral used in this specification indicates the number of the drawing in which the reference numeral first appears.

### DETAILED DESCRIPTION

Embodiments of the present invention provide location determination using wireless Interim Standard 95 (IS-95) Code Division Multiple Access (CDMA) signals. IS-95 signals are available over all urban areas in the United States, and have the greatest bandwidth of any 2 GHz or 2.5 GHz cellular signal. While embodiments of the present invention are described with respect to the IS-95 signal, the techniques disclosed herein can also be applied to any wireless CDMA signal comprising a continuously transmitted pseudonoise sequence, such as a cmda2000 signal and the like.

According to various embodiments, a receiver receives one or more of the IS-95 CDMA signals. A pseudorange unit determines a pseudorange for each of the IS-95 CDMA signals. A location of the receiver is determined based on the pseudorange and the locations of the transmitters of the IS-95 CDMA signals. In some embodiments, the location can be determined by a location unit at the receiver. In other embodiments, the pseudoranges are transmitted to a remote location server, where the location is determined.

Each IS-95 CDMA signal includes a pilot channel comprising a short code sequence. In some embodiments, the pseudorange unit determines the pseudoranges based on the short code sequences.

In some embodiments, the receiver receives a plurality of the IS-95 CDMA signals, where each of the IS-95 CDMA signals has a different short code sequence offset index. In these embodiments, the pseudorange unit identifies the transmitter of each IS-95 CDMA signal based on the offset indexes of the short code sequences. For example, a database relating transmitters to their short code offset indexes can be used.

Some embodiments comprise a time transfer unit to receive an indication of absolute time. In these embodiments, the pseudorange unit determines the offset indexes of the short code sequences based on the absolute time. In some embodiments, when absolute time is not available, the pseudorange unit determines the differences between the offset indexes of the short code sequences, and identifies the transmitter of each IS-95 CDMA signal based on the differences between the offset indexes. For example, the pseudorange unit can identify the transmitter of each IS-95 CDMA signal based on a database of the differences between the offset indexes.

A transmitter identifier is generally encoded into each IS-95 CDMA signal. Some embodiments comprise an IS-95 CDMA decoder to identify one or more of the transmitters of the IS-95 CDMA signals based on the transmitter identifiers encoded into the respective IS-95 CDMA signals.

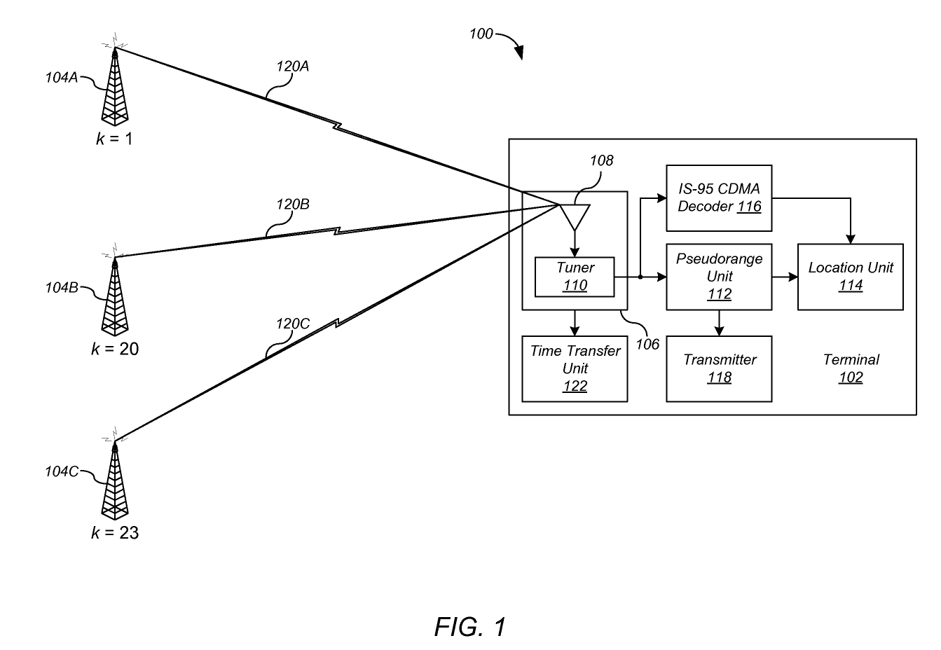

FIG. 1 shows a positioning system 100 according to some embodiments of the present invention. Although in the described embodiments, the elements of positioning system 100 are presented in one arrangement, other embodiments may feature other arrangements, as will be apparent to one skilled in the relevant arts based on the disclosure provided herein.

Positioning system 100 comprises a terminal 102 and one or more IS-95 transmitters 104. In the described embodiment, three IS-95 CDMA transmitters 104A-C are shown, each transmitting a respective wireless IS-95 CDMA signal 120A-C. However, in other embodiments, other numbers of IS-95 CDMA transmitters 104 are used.

When fewer than three IS-95 CDMA transmitters 104 are used, other signals can be used to complete the location determination. These signals can include, for example, global positioning system (GPS) signals, broadcast television signals, Digital Audio Broadcast signals, VHF Omni-directional Radio (VOR) signals, FM radio signals, and the like.

Techniques for determining the position of a terminal using the American Television Standards Committee (ATSC) digital television (DTV) signal are disclosed in U.S. Pat. No. 6,861,984. Techniques for determining the position of a terminal using the European Telecommunications Standards Institute (ETSI) Digital Video Broadcasting (DVB) signal are disclosed in U.S. Pat. No. 7,126,536. Techniques for determining the position of a terminal using the Japanese Integrated Services Digital Broadcasting-Terrestrial (ISDB-T) signal are disclosed in U.S. Pat. No. 6,952,182. Techniques for determining the position of a terminal using the NTSC (National Television System Committee) analog television (TV) signal are disclosed in U.S. Pat. No. 6,559,800 and U.S. Pat. No. 6,522,297. Techniques for determining the position of a terminal using Digital Audio Broadcast signals are disclosed in U.S. Pat. No. 7,042,396. Techniques for determining the position of a terminal using VHF Omni-directional Radio (VOR) signals are disclosed in U.S. patent application Ser. No. 11/535,539 filed Sep. 27, 2006. The disclosures of all of the foregoing are incorporated by reference herein in their entirety.

The IS-95 CDMA signal 120 has a chipping rate of 1.2288 MHz and a channel spacing of 1.25 MHz. The downlink modulation is Quadrature Phase-shift Keying (QPSK) on each CDMA channel, but up to 64 such channels are summed to produce a total signal that approximates a complex Gaussian distribution.

Each IS-95 transmitter 104 allocates 20% of its transmitted power to a pilot channel. The pilot channel transmits a repeating 32,768-chip short code, constructed from a pair of M-sequence generators, one for the in-phase component and one for the quadrature. The timing of the short code sequence is synchronized with GPS time, with every 75th short code sequence tied to an even-numbered integer-second boundary on the GPS clock.

All IS-95 transmitters 104 transmit the same short code sequence, but differ in the code phases that relate their short code sequences to the GPS clock. Each IS-95 transmitter 104 has an assigned code phase offset that is always a multiple of 64 chips. There are 512 possible code phase offsets, indexed as k=0 . . . 511. For example, a IS-95 transmitter 104 with code phase index k=0 starts its short code at GPS time of week (TOW)=0, while a IS-95 transmitter 104 with code phase index k=1 starts its short code 64 chips later. The code phase indexes are assigned to IS-95 transmitters 104 in a reuse pattern that attempts to maximize the distance between IS-95 transmitters 104 having the same code phase. In the example of FIG. 1, k=1 for IS-95 CDMA transmitter 104A, k=20 for IS-95 CDMA transmitter 104B, and k=23 for IS-95 CDMA transmitter 104C.

Referring to FIG. 1, terminal 102 includes a receiver 106 comprising an antenna 108 and a tuner 110, and a pseudorange unit 112. Terminal 102 can include a location unit 114, an IS-95 CDMA decoder 116, a transmitter 118, and a time transfer unit 122. Units 112, 114, and 116 can be implemented as one or more digital signal processors, as software executing on a processor, as discrete elements, or as any combination thereof.

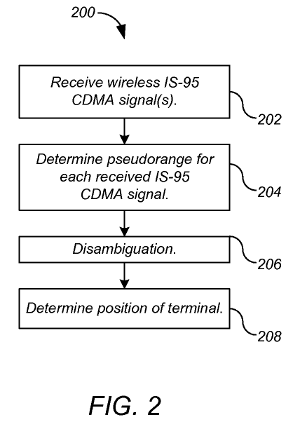

FIG. 2 shows a process 200 for terminal 102 of FIG. 1 according to some embodiments of the present invention. Although in the described embodiments, the elements of process 200 are presented in one arrangement, other embodiments may feature other arrangements, as will be apparent to one skilled in the relevant arts based on the disclosure provided herein.

Receiver 106 receives one or more wireless IS-95 CDMA signals 120 (step 202). Because CDMA cellular systems have dense reuse patterns, any received IS-95 signal 120 includes significant pilot channel energy from multiple IS-95 transmitters 104. Ignoring most multipath effects, the received signal from an active IS-95 network is given by Equation (1).

$$x ( t ) = {\sum }_{i = 0}^{N} {α}_{i} S ( {T}_{0} + t + 64 T {k}_{i} + δ {t}_{i} ) + n ( t ) \qquad ( 1 )$$

where
t is time since the start of the GPS epoch;
N is the number of IS-95 transmitters 104;
S(t) is the IS-95 short code sequence, which repeats every 80/3 milliseconds and has pseudorandom values of ±1±j;
T₀ is some unknown clock offset on receiver 106 of terminal 102;
T is the chipping period, 813.8 ns;
k is the short code offset index of IS-95 transmitter 104i;
δtᵢ is the propagation delay of IS-95 transmitter 104i to receiver 106 of terminal 102, which is δtᵢ≧*crᵢ, where c is the speed of light and rᵢ is the distance to IS-95 transmitter 104i;
aᵢ is a complex gain associated with IS-95 transmitter 104i, having a magnitude that is generally proportional to 1/rᵢ^{p} with p in the range of 3 to 5; and
n(t) is the sum of receiver noise and the non-pilot components of the IS-95 signals 120, which together can be approximated as Gaussian noise having an amplitude at least 6 dB above the S(t) components.

Pseudorange unit 112 determines a pseudorange for each received IS-95 CDMA signal 120 (step 204). In some embodiments, the pseudoranges are determined based on the short codes in the pilot channels of the received IS-95 CDMA signals 120. For example, the received signal S(t) can be correlated with a stored version of the short code.

The autocorrelation P(t) of S(t) is approximately equal to a root raised cosine (RRC) pulse with a bandwidth of 1.2288 MHz. The processing gain of the full short code correlator is 45 dB. Applying the short code correlator to the received IS-95 signal yields the correlation result y(t) given by equation (2).

$$y ( t ) = {S ( t )}^{*} x ( t ) = {\sum }_{i = 0}^{N} {α}_{i} P ( {T}_{0} + t + 64 T {k}_{i} + δ {t}_{i} ) + {S ( t )}^{*} n ( t ) \qquad ( 2 )$$

where the operator “*” represents correlation, not convolution. Assuming that n(t) is dominated by self-interference, the SNR for the largest P(t) components in y(t) is 39 dB for N=1. When all N IS-95 signals 120 are received with equal power, the SNR of the correlator output falls with rising N. Requiring a minimum SNR of 13 dB, typical for reliable detection of pulses, limits N<40 in an equal-power situation. Fortunately, the dependence of aᵢ on rᵢ insures that ground-base reception is far from equal-power, as discussed below. Instead, the SNR of the P(t) component for each IS-95 transmitter 104 falls with rᵢ, so that only the closest IS-95 transmitters 104 will yield usable signals.

As mentioned above, the processing gain and self-interference of the IS-95 system limits N<40, and the actual effective value of N is probably lower. Assuming that IS-95 cells are roughly the same size (radius R₀) in a given area, a typical value of N can be determined for a given loss exponent. A 39 dB SNR on the strongest signal, and a minimum required SNR of 13 dB, yields the limits of Equation (3).

$$\frac{{α}_{s}}{{α}_{w}} < \sqrt{{10}^{2.6}} \qquad ( 3 )$$

where s is the index of the strongest received IS-95 transmitter 104 and w is the index of the weakest. Using the definition of a from Equation (1) yields Equations (4-6).

$$\begin{matrix}\frac{{r}_{w}^{ρ}}{{r}_{s}^{ρ}} < 20 & ( 4 ) \\ \frac{{r}_{w}}{{r}_{s}} = {20}^{1 / ρ} & ( 5 ) \\ {r}_{w} = {20}^{1 / ρ} {r}_{s} & ( 6 )\end{matrix}$$

The number of IS-95 transmitters 104 within the radius r_{w} is roughly given by Equation (7).

$$N \approx {( \frac{{r}_{w}}{{R}_{0}} )}^{2} = {20}^{2 / ρ} {( \frac{{r}_{s}}{{R}_{0}} )}^{2} \qquad ( 7 )$$

Equation (7) exposes a near-far problem; as receiver 106 moves closer to the strongest IS-95 transmitter 104, fewer IS-95 transmitters 104 are receivable.

Normally, rₛ is the distance to the nearest IS-95 transmitter 104, so that rₛ<R₀. This places an upper bound on N, as shown in Equation (8).
N<20^{2/p} (8)

Of course, this is only a rough bound, because cell size is variable and the actual value of p may not be known. But this analysis shows that 1≦N≦7 can be expected for realistic environments.

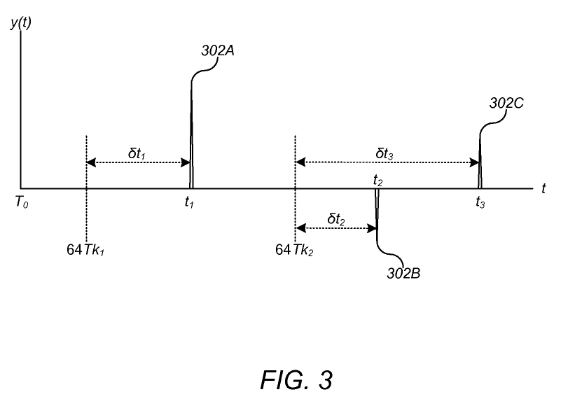

FIG. 3 graphically illustrates an example correlation result y(t) for the positioning system 100 of FIG. 1. Correlation result y(t) includes three pulses 302A-C. Pseudorange unit 112 identifies the IS-95 transmitter 104 that corresponds to each pulse 302 without decoding other parts of the received signal (step 206), a process referred to herein as “disambiguation.” Referring to FIG. 3, pulses 302A-C correspond to IS-95 transmitters 104A-C, respectively.

IS-95 transmitters 104 in any local group of N<512 are identifiable by their k values. Given 3-sector cells and an average cell radius of R₀, the radius of such a local group is on the order of 13R₀. Beyond 13R₀, disambiguation can not be insured, but 20^{1/p}<13 so that a ground-based receiver will never receive signals from beyond 13R₀. There is a further requirement that δt<64T, which is equivalent to requiring that the distance from terminal 102 to a IS-95 transmitter 104 be less than 15.6 km. This can be insured by ignoring all but a few of the most powerful received signals.

In some embodiments, terminal 102 includes a time transfer unit 122 to obtain absolute time. For example, GPS time transfer can be used. As another example, television signals can be used for time transfer, as disclosed in U.S. Provisional Patent Application No. 10/613,919 filed Jul. 3, 2003, the disclosure thereof incorporated by reference herein in its entirety.

When absolute time is known, the clock offset T₀ of the receiver clock is known. When T₀ is known and δt<64T, the short code offset indexes k can be calculated from the delays of pulses 302, as shown in Equation (9).

$${k}_{i} = ⌊ \frac{64 T {k}_{i} + δ {t}_{i}}{64 T} ⌋ , δ {t}_{i} < 64 T \qquad ( 9 )$$

Once k is known for a pulse 302, the corresponding IS-95 transmitter 104 can be identified, and the δt term can be isolated, to give a pseudorange that can be used in time of arrival (TOA) positioning. FIG. 3 shows this graphically. Referring to FIG. 3, two common short code boundaries 64Tk₁ and 64Tk₂ can be identified with knowledge of T₀. The pseudorange for each pulse 302 is then the time difference between that pulse 302 and the previous short code boundary 64Tkᵢ, as shown in FIG. 3. Pulses 302A-C occur at times t₁, t₂, and t₃, respectively. The corresponding pseudoranges are given by Equations (10)-(12).
δt₁=t₁−64Tk₁ (10)
δt₂=t₂−64Tk₂ (11)
δt₃=t₃−64Tk₃ (12)

With known values of k for each IS-95 transmitter 104, and rough knowledge of the location of terminal 102 (that is, to within about 13R₀), the IS-95 transmitters 104 can be identified by location. For example, the values of k can be applied to a database relating IS-95 transmitter 104 locations to sets of values of k.

In some embodiments, absolute time is not available, so T₀ is not known. However, IS-95 signals can still be used for time difference of arrival (TDOA) positioning. The time difference between two P(t) terms i and j is given by Equation (13).
(T₀+64Tkᵢ+δtᵢ)−(T₀+64Tkⱼ+δtⱼ)
=64t(kᵢ−kⱼ)+(δtᵢ−δtⱼ) (13)

Because 0≦δt<64T, and k values are integers, we can define

$${k}_{d} = {k}_{i} - {k}_{j} ⌊ \frac{64 T ( {k}_{i} - {k}_{j} ) + ( δ {t}_{i} - δ {t}_{j} )}{64 T} ⌋ \qquad ( 14 )$$

and then extract a TDOA as
64T(kᵢ−kⱼ)+(δtᵢ−δtⱼ)−64Tk_{d}=δtᵢ−δtⱼ (15)

In these embodiments, the short code offset indices k cannot be calculated directly. However, differences between the short code offset indices k can be measured, and the differences used for disambiguation, and to identify the locations of IS-95 transmitter 104.

Some embodiments include an IS-95 decoder 116. In these embodiments, IS-95 transmitters 104 can be identified by decoding one or more of the IS-95 signals to obtain the transmitter identifier encoded therein. Then the transmitter identifier(s) and the differences between k values can be used to identify the unidentified IS-95 transmitters 104.

In other embodiments, the differences between k values can be used to identify IS-95 transmitters 104. For example, the differences between k values can be applied to a database relating locations to sets of differences between k values.

Referring again to process 200 of FIG. 2, once the pseudoranges and locations of IS-95 transmitters 104 are known, the position of terminal 102 can be determined according to conventional techniques such as least-squares positioning (step 208). When fewer than three pseudoranges are available, they can be supplemented by pseudoranges determined from other types of signals, for example as described above. In some embodiments, terminal 102 includes a location unit 114 to determine the position of terminal 102. In other embodiments, terminal 102 includes a transmitter 118 to transmit the pseudoranges to a remote location unit, which determines the location of terminal 102 based on the transmitted pseudoranges.

In a naive implementation, the cost of applying a full complex-valued 32,768-chip matched filter to a 32,768-chip input is 17.2 billion MAC operations, assuming Nyquist sampling at twice the chipping rate. This case can be reduced considerably, though, by using only a segment of the short code. For example, most IS-95 mobile telephones use only a 256-chip segment of the short code to detect IS-95 pilot signals. The techniques described above can be extended to give projections for different processing gains. Due to self-interference, the minimum processing gain that can produce a usable signal from the nearest IS-95 transmitter 104 is 19 dB, corresponding to an 80-chip correlator with a cost of 42 million add/subtract operations.

IS-95 transmitter clocks are subject to drift during GPS outages. If this drift error is less than 10 microseconds it may be allowed to persist long after GPS service is reestablished, giving a transmitter clock with a known frequency but some small unknown offset in phase. In addition, the cellular operator may also choose to reconfigure a cell and change its short code phase index k. These changes in IS-95 clock phase are infrequent, but can cause positioning errors if not tracked. One inexpensive way to track changes is to use measurements from terminals 102 who report back more measurements than are actually needed for a position fix. For example, a terminal 102 may take a collection of various signal measurements (GPS, TV, IS-95, etc.) and communicate them to a location server. Normally, the measurement set is significantly larger than the minimum required for a position calculation. If the measurement from a specific IS-95 transmitter 104 is grossly inconsistent with the calculated position of a terminal 102, this is an indication that the IS-95 transmitter's signal parameters may have changed since they were last updated. The measurements reported by the terminals 102 can be used to update the location server's parameter set for that IS-95 transmitter 104. To prevent bad terminal 102 measurements from corrupting the location server data, this update process can make use of quality estimates at terminals 102 or combine measurements from several overdetermined terminals 102.

Embodiments of the invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated units).

A number of implementations of the invention have been described. Nevertheless, it will be understood that various modifications may be made without departing from the spirit and scope of the invention. Accordingly, other implementations are within the scope of the following claims.

What is claimed is:

1. An apparatus comprising:
a receiver to receive a wireless Code Division Multiple Access (CDMA) signal comprising a continuously transmitted pseudonoise sequence; and
a pseudorange unit to determine a pseudorange based on the wireless CDMA signal;
wherein a location of the receiver is determined based on the pseudorange and a location of a transmitter of the wireless CDMA signal.

2. The apparatus of claim 1, wherein the wireless CDMA signal comprises at least one of:
an Interim Standard 95 (IS-95) signal; and
a cdma2000 signal.

3. The apparatus of claim 1, further comprising:
a location unit to determine the location of the receiver based on the pseudorange and the location of the transmitter of the wireless CDMA signal.

4. The apparatus of claim 1, wherein the wireless CDMA signal comprises a pilot channel comprising a short code sequence:
wherein the pseudorange unit determines the pseudorange based on the short code sequence.

5. The apparatus of claim 1:
wherein the receiver receives a plurality of the wireless CDMA signals, wherein each of the wireless CDMA signals comprises a pilot channel comprising a short code sequence, wherein each of the short code sequences has a different offset index; and
wherein the pseudorange unit identifies a respective transmitter for each of the wireless CDMA signals based on the respective offset indexes of the short code sequences.

6. The apparatus of claim 5, further comprising:
a time transfer unit to receive an indication of absolute time;
wherein the pseudorange unit determines the offset indexes of the short code sequences based on the absolute time.

7. The apparatus of claim 5:
wherein the pseudorange unit determines differences between the offset indexes of the short code sequences, and identifies the respective transmitter for each of the wireless CDMA signals based on the differences between the offset indexes.

8. The apparatus of claim 7:
wherein the pseudorange unit identifies the respective transmitter for each of the wireless CDMA signals based on a database of the differences between the offset indexes.

9. The apparatus of claim 5, further comprising:
a wireless CDMA decoder to identify at least one of the transmitters of the wireless CDMA signals based on transmitter identifiers encoded into the respective wireless CDMA signals.

10. An apparatus comprising:
receiver means for receiving a wireless Code Division Multiple Access (CDMA) signal comprising a continuously transmitted pseudonoise sequence; and
pseudorange means for determining a pseudorange based on the wireless CDMA signal;
wherein a location of the receiver means is determined based on the pseudorange and a location of a transmitter of the wireless CDMA signal.

11. The apparatus of claim 10, wherein the wireless CDMA signal comprises at least one of:
an Interim Standard 95 (IS-95) signal; and
a cdma2000 signal.

12. The apparatus of claim 10, further comprising:
location means for determining the location of the receiver based on the pseudorange and the location of the transmitter of the wireless CDMA signal.

13. The apparatus of claim 10, wherein the wireless CDMA signal comprises a pilot channel comprising a short code sequence:
wherein the pseudorange means determines the pseudorange based on the short code sequence.

14. The apparatus of claim 10:
wherein the receiver means receives a plurality of the wireless CDMA signals, wherein each of the wireless CDMA signals comprises a pilot channel comprising a short code sequence, wherein each of the short code sequences has a different offset index; and
wherein the pseudorange means identifies a respective transmitter for each of the wireless CDMA signals based on the respective offset indexes of the short code sequences.

15. The apparatus of claim 14, further comprising:
time transfer means for receiving an indication of absolute time;
wherein the pseudorange means determines the offset indexes of the short code sequences based on the absolute time.

16. The apparatus of claim 14:
wherein the pseudorange means determines differences between the offset indexes of the short code sequences, and identifies the respective transmitter for each of the wireless CDMA signals based on the differences between the offset indexes.

17. The apparatus of claim 16:
wherein the pseudorange means identifies the respective transmitter for each of the wireless CDMA signals based on a database of the differences between the offset indexes.

18. The apparatus of claim 14, further comprising:
decoder means for identifying at least one of the transmitters of the wireless CDMA signals based on transmitter identifiers encoded into the respective wireless CDMA signals.

19. A method comprising:
receiving, at a receiver, a wireless Code Division Multiple Access (CDMA) signal comprising a continuously transmitted pseudonoise sequence; and
determining a pseudorange based on the wireless CDMA signal;
wherein a location of the receiver is determined based on the pseudorange and a location of a transmitter of the wireless CDMA signal.

20. The method of claim 19, wherein the wireless CDMA signal comprises at least one of:
an Interim Standard 95 (IS-95) signal; and
a cdma2000 signal.

21. The method of claim 19, further comprising:
determining the location of the receiver based on the pseudorange and the location of the transmitter of the wireless CDMA signal.

22. The method of claim 19, wherein the wireless CDMA signal comprises a pilot channel comprising a short code sequence:
wherein the pseudorange means determines the pseudorange based on the short code sequence.

23. The method of claim 19, further comprising:
receiving a plurality of the wireless CDMA signals, wherein each of the wireless CDMA signals comprises a pilot channel comprising a short code sequence, wherein each of the short code sequences has a different offset index; and
identifying a respective transmitter for each of the wireless CDMA signals based on the respective offset indexes of the short code sequences.

24. The method of claim 23, further comprising:
receiving an indication of absolute time; and
determining the offset indexes of the short code sequences based on the absolute time.

25. The method of claim 23, further comprising:
determining differences between the offset indexes of the short code sequences; and
identifying the respective transmitter for each of the wireless CDMA signals based on the differences between the offset indexes.

26. The method of claim 25, further comprising:
identifying the respective transmitter for each of the wireless CDMA signals based on a database of the differences between the offset indexes.

27. The method of claim 23, further comprising:
identifying at least one of the transmitters of the wireless CDMA signals based on transmitter identifiers encoded into the respective wireless CDMA signals.

28. Computer-readable media embodying instructions executable by a computer to perform a method comprising:
receiving, at a receiver, a wireless Code Division Multiple Access (CDMA) signal comprising a continuously transmitted pseudonoise sequence; and
determining a pseudorange based on the wireless CDMA signal;
wherein a location of the receiver is determined based on the pseudorange and a location of a transmitter of the wireless CDMA signal.

29. The computer-readable media of claim 28, wherein the wireless CDMA signal comprises at least one of:
an Interim Standard 95 (IS-95) signal; and
a cdma2000 signal.

30. The computer-readable media of claim 28, wherein the method further comprises:
determining the location of the receiver based on the pseudorange and the location of the transmitter of the wireless CDMA signal.

31. The computer-readable media of claim 28, wherein the wireless CDMA signal comprises a pilot channel comprising a short code sequence:
wherein the pseudorange means determines the pseudorange based on the short code sequence.

32. The computer-readable media of claim 28, wherein the method further comprises:
receiving a plurality of the wireless CDMA signals, wherein each of the wireless CDMA signals comprises a pilot channel comprising a short code sequence, wherein each of the short code sequences has a different offset index; and
identifying a respective transmitter for each of the wireless CDMA signals based on the respective offset indexes of the short code sequences.

33. The computer-readable media of claim 32, wherein the method further comprises:
receiving an indication of absolute time; and
determining the offset indexes of the short code sequences based on the absolute time.

34. The computer-readable media of claim 32, wherein the method further comprises:
determining differences between the offset indexes of the short code sequences; and
identifying the respective transmitter for each of the wireless CDMA signals based on the differences between the offset indexes.

35. The computer-readable media of claim 34, wherein the method further comprises:
identifying the respective transmitter for each of the wireless CDMA signals based on a database of the differences between the offset indexes.

36. The computer-readable media of claim 32, wherein the method further comprises:
identifying at least one of the transmitters of the wireless CDMA signals based on transmitter identifiers encoded into the respective wireless CDMA signals.
